(19) United States
(12) Patent Application Publication
(10) Pub. No.: US 2009/0298022 A1
(43) Pub. Date: Dec. 3, 2009

(54) Math learning puzzles for geometry, measurement, and number sense

(76) Inventor: Mary Kay Bacallao Fanning, Fayetteville, GA (US)

Correspondence Address: MARY KAY BACALLAO, 160 BRANDENBURG WAY, FAYETTEVILLE, GA, 30215, US

(21) Appl. No.: 12/454,638

(22) Filed: May 21, 2009

Related U.S. Application Data
(60) Provisional application No. 61/128,921, filed on May 27, 2008.

(51) Int. Cl. G09B 19/02

(52) U.S. Cl. 434/187

(57) ABSTRACT

Three puzzles including a 10 cm square with contrasting colors on the top and on the bottom cut diagonally at 3 cm and 10 cm, respectively, from each corner to form 4 puzzle pieces, a five layer 12 inch square cut into different sized pieces to represent the liquid measurement units including gallon, quart, pint, cup, fluid ounce, tablespoon, and teaspoon, and a ten layer puzzle with the digits 0-9 where each layer has a separate puzzle and each puzzle contains the number of pieces that the symbol represents.

### CROSS REFERENCE TO RELATED APPLICATIONS

NA

### STATEMENT REGARDING FEDERALLY SPONSORED RESEARCH OR DEVELOPMENT

NA

### REFERENCE TO SEQUENCE LISTING, A TABLE, OR A COMPUTER PROGRAM LISTING COMPACT DISC APPENDIX

NA

### BACKGROUND OF THE INVENTION

1. Field of the Invention

The field of the invention relates to a structure and method developed that can be used to assist pre-kindergarten through high school level students in learning about geometry, including types of angles, flips, turns, rotations, and types of quadrilaterals; about measurement, including gallons, half gallons, quarts, pints, cups, fluid ounces, tablespoons, and teaspoons as they relate to fractions; and about number sense, including concepts of number from zero to nine.

2. Background Art

The invention was developed to allow students to learn about math topics through creative play and exploration. Three puzzles address student learning through doing in the fields of geometry, measurement, and number sense. The geometry puzzle, Quadrilateral Pieces: A Geometry Puzzle, utilizes four identical non-regular quadrilaterals with five unique quadrilateral solutions when used together. With these pieces, students can use authentic problem solving to practice flips, turns, and rotations in an effort to find solutions. Students develop spatial sense and geometric reasoning as they manipulate the puzzle pieces.

The measurement puzzle, Liquid Measure Fractions: A Puzzle with Quarts, Pints, Cups and More, uses the gallon as the base unit in the development of fraction concepts. The puzzle pieces show the fractional relationships among the customary liquid measurement units including gallons, half gallons, quarts, pints, cups, fluid ounces, tablespoons, and teaspoons. Students can use the puzzle to explore the various fractional relationships.

The puzzle is also useful in solving conversion problems involving customary liquid measure units.

The number sense puzzle, Rainbow Number Shapes: A Conceptual Puzzle for Early Numeracy, was developed to provide an opportunity for students to learn about the value of the digits 0-9 by putting together puzzle pieces to form the number symbols. Each number symbol has a puzzle. The number of pieces in the puzzle corresponds with the number represented by the symbol. As students put the puzzles together, they will gain a visual and conceptual understanding of the numbers that the symbols represent. The pieces are colored in rainbow colors with additional colors being added as the numbers increase.

### BRIEF SUMMARY OF THE INVENTION

The invention consists of three puzzles, a geometry puzzle, a measurement puzzle, and a number sense puzzle. The first puzzle consists of a 10×10 cm square cut into four identical pieces with one side 3 cm in length and one side 7 cm in length. The top is one color and the bottom is a different color. The second puzzle is a 5 layer 24.73951 cm by 24.73951 cm square base 3-dimensional puzzle with a height of 6.18478 cm. When each layer is put together, the dimensions are the same. The first layer can contain exactly a gallon of liquid measure on the inside. On the bottom of the first layer, a sampling of the other layers of the puzzle is printed as a 2-dimensional representation. The second layer is divided into 2 equivalent pieces that can contain exactly one half gallon each on the inside and 2 quarts printed on the bottom of each piece as a 2 dimensional representation. The third layer is divided into 4 equivalent pieces that can contain exactly one quart each on the inside and 2 pints printed on the bottom of each piece. The fourth layer is divided into 8 equivalent pieces that can contain one pint each on the inside and 2 cups printed on the bottom of each piece. The fifth layer is divided into 16 equivalent cubes that can contain 1 cup each on the inside and the bottom of each cup is printed in several different ways. Two are printed with fluid ounce markings. Two are printed with tablespoon markings. Two are printed with teaspoon markings. Two are printed with fluid ounce and tablespoon markings. Two are printed with fluid ounce and teaspoon markings. Two are printed with tablespoon and teaspoon markings. Four are printed with fluid ounce, tablespoon, and teaspoon markings. Pictures of the actual dairy containers are printed on the inside of each piece with a label describing the size of the container. The third puzzle is a set of digits from 0-9. Each digit has a separate puzzle. The number of pieces in the puzzle corresponds with the number represented by the symbol.

### BRIEF DESCRIPTION OF THE SEVERAL VIEWS OF THE DRAWING

FIG. 1 depicts a view of the physical structure of the geometry puzzle from above.

FIG. 2 depicts a view of the physical structure of the liquid measure puzzle, layer 1, front side, 1 piece.

FIG. 3 depicts an enlarged view of the physical structure of the liquid measure puzzle, layer 1, back side, one piece.

FIG. 4 depicts a view of the physical structure of the liquid measure puzzle, layer 2, front side, half gallons, 2 pieces.

FIG. 5 depicts a view of the physical structure of the liquid measure puzzle, layer 3, front side, quarts. It is also the back side of layer 2.

FIG. 6 depicts a view of the physical structure of the liquid measure puzzle, layer 4, front side, pints. It is also on the back side of layer 3.

FIG. 7 depicts a view of the physical structure of the liquid measure puzzle, layer 5, cups. It is also the back side of layer 4.

FIG. 8 depicts a close-up of the fluid ounce view of the physical structure of the liquid measure puzzle, layer 5, back side. There are 16 “cup” size pieces. Two of the cup pieces have this view on the back.

FIG. 9 depicts a close-up of the tablespoon view of the physical structure of the liquid measure puzzle, layer 5, back side. There are 16 “cup” size pieces. Two of the cup pieces have this view on the back.

FIG. 10 depicts a close-up of the teaspoon view of the physical structure of the liquid measure puzzle, layer 5, back side. There are 16 “cup” size pieces. Two of the cup pieces have this view on the back.

FIG. 11 depicts a close-up of the teaspoon and fluid ounce combination view of the physical structure of the liquid measure puzzle, layer 5, back side. There are 16 “cup” size pieces. Two of the cup pieces have this view on the back.

FIG. 12 depicts a close-up of the fluid ounce, tablespoon, and teaspoon view of the physical structure of the liquid measure puzzle, layer 5, back side. There are 16 “cup” size pieces. Four of the cup pieces have this view on the back.

FIG. 13 depicts a close-up of the tablespoon and teaspoon combination view of the physical structure of the liquid measure puzzle, layer 5, back side. There are 16 “cup” size pieces. Two of the cup pieces have this view on the back.

FIG. 14 depicts a close-up of the tablespoon and fluid ounce combination view of the physical structure of the liquid measure puzzle, layer 5, back side. There are 16 “cup” size pieces. Two of the cup pieces have this view on the back.

FIG. 15 depicts the physical structure of the rainbow number shape puzzle from above when each puzzle is taken out and laid side by side.

FIG. 16 depicts the physical structure of the rainbow number shape puzzle from the long side.

FIG. 17 depicts the physical structure of the rainbow number shape puzzle from the short side.

### DETAILED DESCRIPTION OF THE INVENTION

1. Description of Quadrilateral Pieces: A Geometry Puzzle

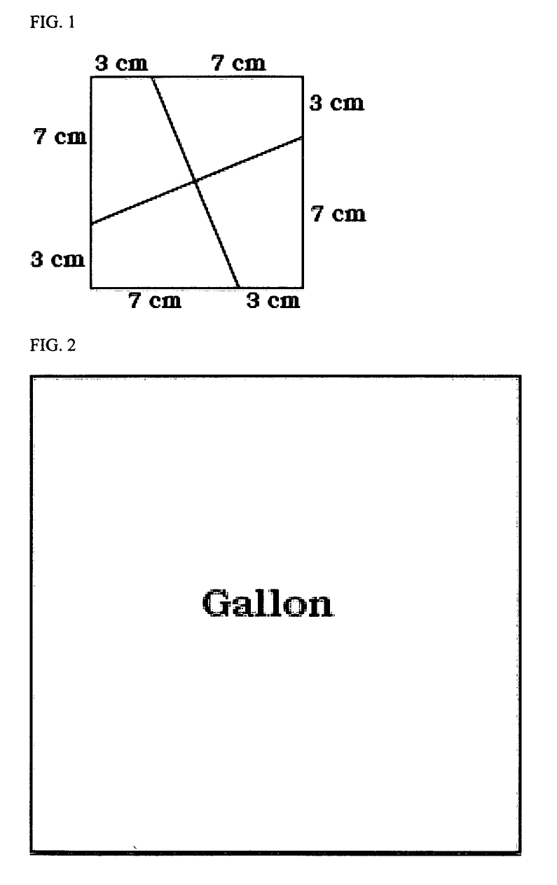

The puzzle consists of four identical pieces formed from a square. The top of the puzzle is one color and the bottom of the puzzle is another color. (FIG. 1)

2. Function of the Quadrilateral Pieces: A Geometry Puzzle

The four pieces are to be used to form five different quadrilateral solutions. The solutions include: a square, a square with a square hole in the middle, a rectangle with a rectangular hole in the middle, a parallelogram, and a trapezoid. The pieces are also to be used for exploration of right, acute and obtuse angles. The pieces are also to be used for exploration and practice in flips, turns, and rotations.

3. Description of Liquid Measure Fractions: A Puzzle with Quarts, Pints, Cups and More

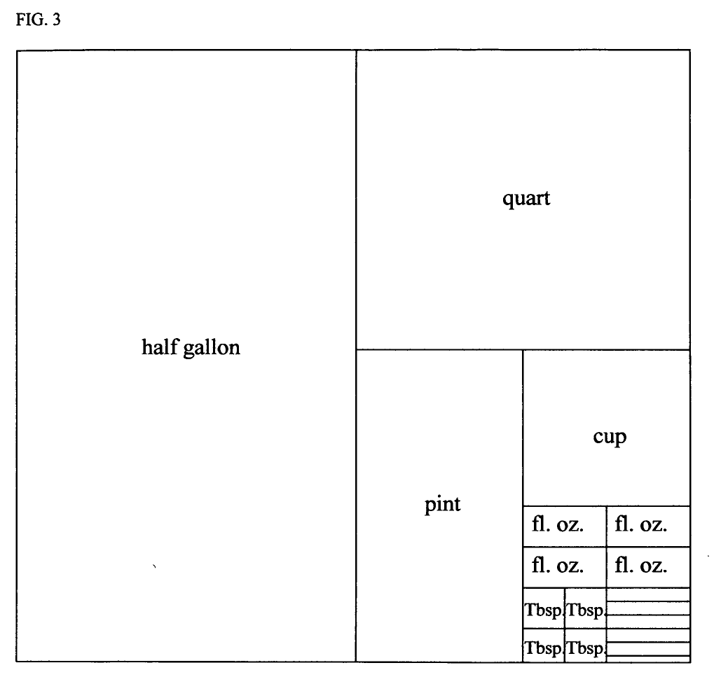

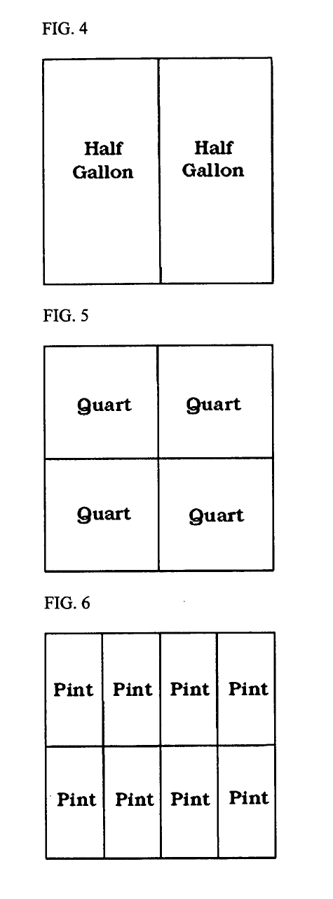

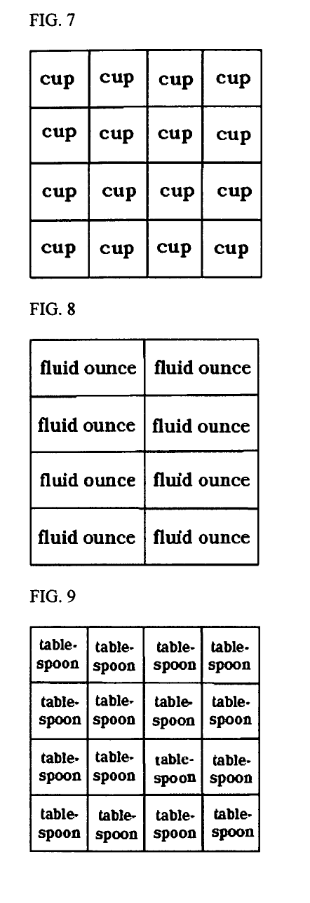

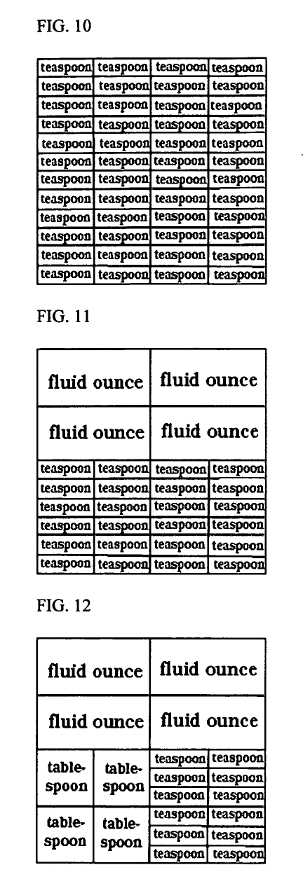

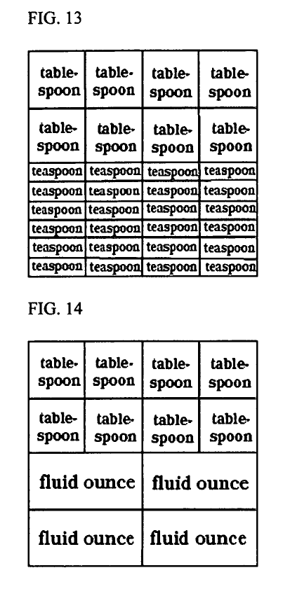

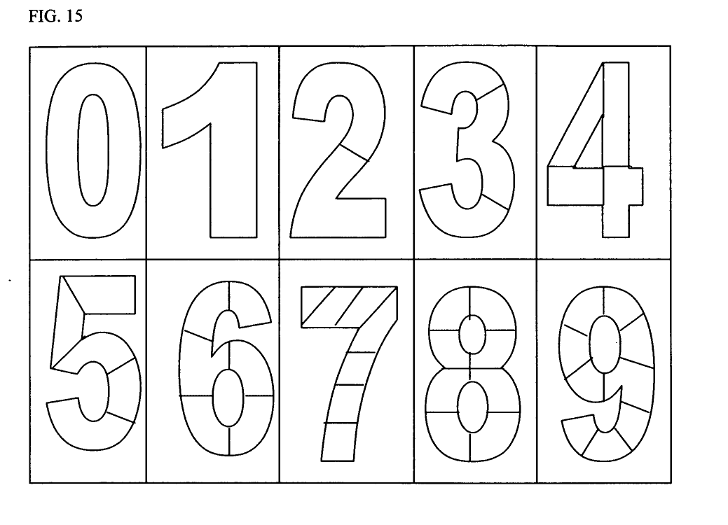

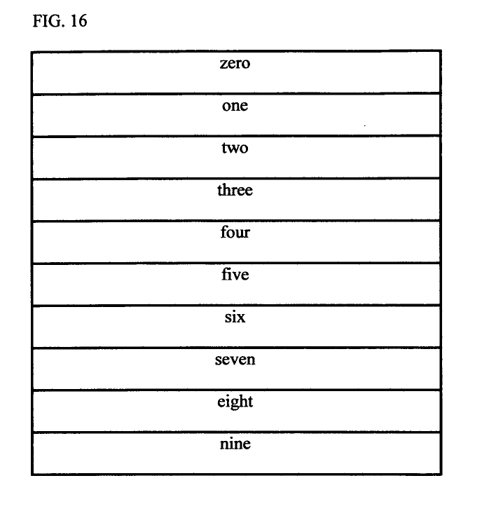

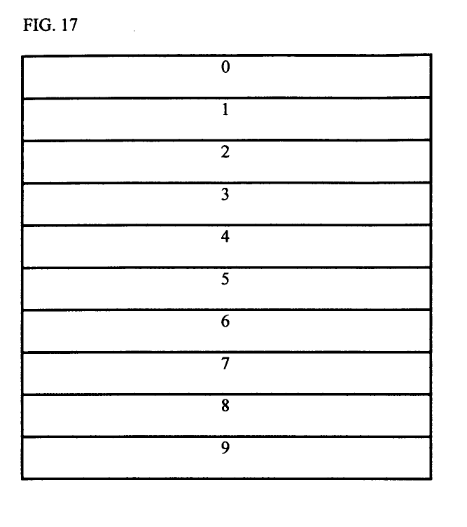

There are five layers to this 24.73951 cm by 24.73951 cm by 6.18487 cm puzzle. The layers have a base and sides but no top. All of the layers have the same measures and fit back of the first layer, all the pieces of the puzzle from all the other layers are shown. (FIG. 3) The second layer has 2 identical pieces that may contain exactly a half gallon each. (FIG. 4) The back of the second layer has quart illustrations. (FIG. 5) The third layer has 4 identical pieces that may contain exactly one quart each. (FIG. 5) The back of the third layer has pint illustrations. (FIG. 6) The fourth layer has 8 identical pieces that may contain exactly one pint each. (FIG. 6) The back of the fourth layer has cup illustrations. (FIG. 7) The fifth layer has 16 pieces that may contain exactly one cup each. (FIG. 7) The back of the cup pieces on the fifth layer have different illustrations. Two have fluid ounce illustrations. (FIG. 8) Two have tablespoon illustrations. (FIG. 9) Two have teaspoon illustrations. (FIG. 10) Two have a combination of fluid ounce and teaspoon illustrations. (FIG. 11) Four have a combination of fluid ounce, tablespoon, and teaspoon illustrations. (FIG. 12) Two have a combination of tablespoon and teaspoon illustrations. (FIG. 13) Two have a combination of tablespoon and fluid ounce illustrations. (FIG. 14)

4. Function of Liquid Measure Fractions: A Puzzle with Quarts, Pints, Cups and More

The relationships among the customary liquid measurement units can be explored by taking the puzzle apart and then putting it back together again with various interchangeable combinations. Students can fill the pieces with liquids and transfer the liquids from one container to another to explore the relationships among the measurement units. The puzzle can also be used to solve problems involving conversion from one customary liquid measure unit to another. The puzzle pieces can assist problem solvers in understanding what number they need to multiply or divide by to get the correct answer. The puzzle pieces can be used as fractions to assist in determining equivalent fractional measures.

5. Rainbow Number Shapes: A Conceptual Puzzle for Early Numeracy

There is a separate puzzle for each number symbol from zero to nine. The number of pieces in the puzzle corresponds with the number represented by the symbol. Within each puzzle, there is a separate color for each piece of the puzzle. The pieces are in order according to the rainbow with additional colors being included as the numbers increase.

6. Function of Rainbow Number Shapes: A Conceptual Puzzle for Early Numeracy

The purpose of this puzzle is to provide an opportunity for early learners to gain understanding of the value of the numbers as they familiarize themselves with the symbols and manipulate the shapes to construct the numbers. As students put the puzzles together, they can gain a visual and conceptual understanding of the numbers that the symbols represent.

### ABSTRACT OF THE DISCLOSURE

Three puzzles including a 10 cm square with contrasting colors on the top and on the bottom cut diagonally at 3 cm and 10 cm, respectively, from each corner to form 4 puzzle pieces, a five layer 24.73951 cm by 24.73951 cm by 6.18487 cm puzzle cut into different sized pieces to contain and/or represent the liquid measurement units including gallon, quart, pint, cup, fluid ounce, tablespoon, and teaspoon, and a ten layer puzzle with the digits 0-9 where each layer has a separate puzzle and each puzzle contains the number of pieces that the symbol represents.

I claim:

1. A puzzle with 4 pieces cut from one 10 centimeter square with contrasting colors on the top and bottom. Diagonal lines cut through the square twice to form 4 detached puzzle pieces. The diagonal lines are 3 centimeters from one corner of the square and 7 centimeters from the other corner. These two cuts form the 4 detached puzzle pieces.

2. The method of claim 1, comprising: the 4 puzzle pieces are to be used to increase experiential knowledge of quadrilaterals by putting the pieces together to form a square with a square hole in the middle, the original square, a rectangle with a rectangular hole in the middle, a trapezoid, and a parallelogram. The puzzle pieces are to be used as a learning tool for the math concepts of right, acute, and obtuse angles; and flips, turns, and rotations.

3. A 5 layer 24.73951 cm by 24.73951 cm square base 3-dimensional puzzle with a height of 6.18478 cm. When each layer is put together, the dimensions are the same. The first layer can contain exactly a gallon of liquid measure on the inside. On the bottom of the first layer, a sampling of the other layers of the puzzle is printed as a 2-dimensional representation. The second layer is divided into 2 equivalent pieces that can contain exactly one half gallon each on the inside and 2 quarts printed on the bottom of each piece as a 2 dimensional representation. The third layer is divided into 4 equivalent squares that can contain exactly one quart each on the inside and 2 pints printed on the bottom of each piece. The fourth layer is divided into 8 equivalent pieces that can contain one pint each on the inside and 2 cups printed on the bottom of each piece. The fifth layer is divided into 16 equivalent squares that can contain 1 cup each on the inside and the bottom of each cup is printed in several different ways. Two are printed with fluid ounce markings. Two are printed with tablespoon markings. Two are printed with teaspoon markings. Two are printed with fluid ounce and tablespoon markings. Two are printed with fluid ounce and teaspoon markings. Two are printed with tablespoon and teaspoon markings. Four are printed with fluid ounce, tablespoon, and teaspoon markings. Pictures of the actual dairy containers are printed on the inside of each piece with a label describing the size of the container.

4. The method of claim 3 comprising; the puzzle pieces are to be used as a teaching and/or learning tool by taking the components of a gallon apart and then putting the components of a gallon together to gain understanding of the relative value of the units. The puzzle pieces are used to make size comparisons among units of liquid measure. The puzzle pieces are used to convert one unit of liquid measure to another unit of liquid measure by placing one representation on top of another to determine how many are needed to create equivalent amounts with different liquid measurement units.

5. A ten layer puzzle with a separate layer for each digit from 0-9. Each number symbol has a puzzle and they stack together in order from 0-9, with 0 on the top and 9 on the bottom layer. For each digit symbol from 0-9, the number of pieces in the puzzle corresponds with the number represented by the symbol. The pieces for each puzzle layer are colored in rainbow colors with additional colors being added as the numbers increase. The bottom of each layer is cut so that the puzzle number below it fits into the indentation for the raised number that is the next number in the sequence.

6. The method for claim 5, comprising: the ten layer number puzzle is to be used to enable students to learn about the value of the digits 0-9 by taking apart and putting together puzzle pieces to form the number symbols. As students put the puzzles together, they can gain a visual and conceptual understanding of the numbers that the symbols represent. As they stack the layers of the puzzle pieces, this can enable them to gain an understanding of the correct sequence of the numbers.
